(19) United States
(12) Patent Application Publication
(10) Pub. No.: US 2025/0146094 A1
(43) Pub. Date: May 8, 2025

(54) COLD-ROLLED STEEL SHEET AND METHOD FOR MANUFACTURING SAME

(71) Applicant: NIPPON STEEL CORPORATION, Tokyo (JP)

(72) Inventors: Takuya NISHIO, Tokyo (JP); Masafumi AZUMA, Tokyo (JP); Ryosuke NAKAMURA, Tokyo (JP)

(73) Assignee: NIPPON STEEL CORPORATION, Tokyo (JP)

(21) Appl. No.: 18/834,966

(22) PCT Filed: Dec. 23, 2022
(86) PCT No.: PCT/JP2022/047518

§ 371 Date: Jul. 31, 2024

(30) Foreign Application Priority Data
Feb. 9, 2022 (JP) 2022-018412

(51) Int. Cl. C21D 9/46; C21D 6/00; C21D 8/02; C22C 38/00; C22C 38/02; C22C 38/04; C22C 38/06; C22C 38/12; C22C 38/14; C22C 38/44; C22C 38/58

(52) U.S. Cl. CPC C21D 9/46; C21D 6/005; C21D 6/008; C21D 8/0205; C21D 8/0226; C21D 8/0236; C21D 8/0263; C22C 38/001; C22C 38/002; C22C 38/005; C22C 38/02; C22C 38/04; C22C 38/06; C22C 38/12; C22C 38/14; C22C 38/44; C22C 38/58; C21D 2211/001; C21D 2211/002; C21D 2211/005; C21D 2211/008

(57) ABSTRACT

This cold-rolled steel sheet has a predetermined chemical composition, in which a metallographic structure at a ¼ depth position, which is a ¼ thickness position from a surface, contains, by volume percentage, retained austenite: more than 1.0% and less than 8.0%, tempered martensite: 80.0% or more, ferrite and bainite: 0% or more and 15.0% or less in total, and martensite: 0% or more and 5.0% or less, and in the metallographic structure, a prior γ grain size is 5.0 μm or more and 25.0 μm or less, and a number density of retained γ on a prior γ grain boundary is 100/mm² or less.

### TECHNICAL FIELD OF THE INVENTION

The present invention relates to a cold-rolled steel sheet and a method for manufacturing the same.

Priority is claimed on Japanese Patent Application No. 2022-018412, filed Feb. 9, 2022, the content of which is incorporated herein by reference.

### RELATED ART

Today, as industrial technology fields are highly divided, materials used in each technology field require special and advanced performance. In particular, with regard to steel sheets for a vehicle, in order to reduce a weight of a vehicle body and improve fuel efficiency in consideration of the global environment, there is a significantly increasing demand for cold rolled high tensile strength steel sheets having a small sheet thickness and excellent formability. Among the steel sheets for a vehicle, particularly for cold-rolled steel sheets used for vehicle body frame components, high strength is required, and furthermore, high formability for wide applications is required.

In addition, since vehicle components are formed by pressing or the like, the vehicle components are required to have excellent formability (for example, uniform elongation or bendability) even with high strength.

In addition, susceptibility to hydrogen embrittlement increases with high-strengthening. A steel member used in vehicles has a risk of hydrogen embrittlement cracking due to hydrogen generated during manufacturing and use of the vehicles. During manufacturing, hydrogen is generated in a step of heating a material or in an electrodeposition coating step, and a portion thereof is stored in the steel member. In addition, during use, hydrogen is generated due to corrosion of the steel member.

Therefore, in recent years, examples of properties required for a steel sheet for a vehicle include a tensile strength (TS) of 1,310 MPa or more, a uniform elongation of 4.0% or more, R/t, which is a ratio of a limit bend (minimum bend radius) R in 90° V-bending to a sheet thickness, of 5.0 or less, and superior hydrogen embrittlement resistance.

Although it is effective to provide a structure containing ferrite in order to secure ductility such as uniform elongation, a secondary phase needs to be hardened to obtain a strength of 1,310 MPa or more with the structure containing ferrite. However, a hard secondary phase deteriorates hole expansibility.

As a technique for improving hole expansibility of a high strength steel sheet, a steel sheet containing tempered martensite as a primary phase has been proposed (refer to, for example, Patent Documents 1 and 2). Patent Documents 1 and 2 describe that the hole expansibility is excellent when a microstructure is tempered martensite single structure.

However, the invention of Patent Document 1 has a tensile strength as low as less than 1,310 MPa. Therefore, in a case of aiming for further high-strengthening, it is necessary to further improve workability that deteriorates accordingly. In addition, although the invention of Patent Document 2 can achieve a strength as high as 1,310 MPa or more, since the steel sheet is cooled to near room temperature during cooling during quenching, there is a problem in that a volume percentage of retained austenite is small and high uniform elongation cannot be obtained.

In addition, Patent Document 3 proposes a steel sheet using a transformation induced plasticity (TRIP) effect caused by retained austenite as a technique for achieving both high-strengthening and high formability.

In addition, since the steel sheet of Patent Document 3 has ferrite, it is difficult to obtain a strength as high as 1,310 MPa or more, and a strength difference in the structure causes deterioration in hole expansion formability.

In addition, Patent Document 4 describes that a high strength cold-rolled steel sheet having a tensile strength (TS) of 1,310 MPa or more, a uniform elongation of 5.0% or more, a ratio (R/t) of a limit bend radius R in 90° V-bending to a sheet thickness t of 5.0 or less, and superior hydrogen embrittlement resistance is obtained by softening of a surface layer and refinement of a hard phase of a surface layer area through dew point control during annealing after setting a structure (metallographic structure) at a ¼ thickness position from a surface to a structure primarily containing tempered martensite including retained austenite.

However, in recent years, there has been a demand for further improvement in properties.

### PRIOR ART DOCUMENT

### Patent Document

Patent Document 1: Japanese Unexamined Patent Application, First Publication No. 2009-30091

Patent Document 2: Japanese Unexamined Patent Application, First Publication No. 2010-215958

Patent Document 3: Japanese Unexamined Patent Application, First Publication No. 2006-104532

Patent Document 4: PCT International Publication No. WO2019/181950

### SUMMARY OF THE INVENTION

### Problems to be Solved by the Invention

As described above, in recent years, regarding steel sheets having a high strength, which is a tensile strength (TS) of 1,310 MPa or more, there has been a demand for steel sheets having higher formability and hydrogen embrittlement resistance.

The present invention has been made to solve the above problems, and an object thereof is to provide a cold-rolled steel sheet having excellent formability, which is an issue with high strength steel sheets, and excellent hydrogen embrittlement resistance, and a method for manufacturing the same.

Here, the cold-rolled steel sheet includes not only a cold-rolled steel sheet having no plating layer on a surface but also a hot-dip galvanized steel sheet and a hot-dip galvannealed steel sheet.

### Means for Solving the Problem

The present inventors conducted a detailed investigation on the effects of a chemical composition, a metallographic structure, and manufacturing conditions on mechanical properties of a high strength cold-rolled steel sheet. As a result, it was found that hydrogen embrittlement resistance is improved by forming a metallographic structure to be a structure primarily containing tempered martensite containing a predetermined amount or more of retained austenite and leaving no retained austenite in the vicinity of prior γ (austenite) grain boundaries.

In addition, it was found that by controlling the distribution of carbides in a hot-rolled steel sheet and adjusting conditions during a heat treatment, it is possible to perform control for leaving no retained austenite in the vicinity of prior γ grain boundaries.

The present invention has been made in view of the above findings. The gist of the present invention is as follows.
[1] A cold-rolled steel sheet according to an aspect of the present invention includes, as a chemical composition, by mass %: C: more than 0.140% and less than 0.400%; Si: 1.00% or less; Mn: more than 1.30% and less than 4.00%; P: 0.100% or less; S: 0.010% or less; Al: 0.100% or less; N: 0.0100% or less; Ti: 0% or more and less than 0.050%; Nb: 0% or more and less than 0.050%; V: 0% or more and 0.50% or less; Cu: 0% or more and 1.00% or less; Ni: 0% or more and 1.00% or less; Cr: 0% or more and 1.00% or less; Mo: 0% or more and 0.50% or less; B: 0% or more and 0.0100% or less; Ca: 0% or more and 0.0100% or less; Mg: 0% or more and 0.0100% or less; REM: 0% or more and 0.0500% or less; Bi: 0% or more and 0.050% or less; and a remainder: Fe and impurities, in which a metallographic structure at a ¼ depth position, which is a ¼ thickness position from a surface, contains, by volume percentage, retained austenite: more than 1.0% and less than 8.0%, tempered martensite: 80.0% or more, ferrite and bainite: 0% or more and 15.0% or less in total, and martensite: 0% or more and 5.0% or less, and in the metallographic structure, a prior γ grain size is 5.0 μm or more and 25.0 μm or less, and a number density of retained γ on a prior γ grain boundary is 100/mm² or less.
[2] In the cold-rolled steel sheet according to [1], a tensile strength may be 1,310 MPa or more, a uniform elongation may be 4.0% or more, and R/t, which is a ratio of a limit bend R to a sheet thickness at 90° V-bending may be 5.0 or less.
[3] In the cold-rolled steel sheet according to [1] or [2], the chemical composition may contain, by mass %, one or two or more selected from Ti: 0.001% or more and less than 0.050%, Nb: 0.001% or more and less than 0.050%, V: 0.01% or more and 0.50% or less, Cu: 0.01% or more and 1.00% or less, Ni: 0.01% or more and 1.00% or less, Cr: 0.01% or more and 1.00% or less, Mo: 0.01% or more and 0.50% or less, B: 0.0001% or more and 0.0100% or less, Ca: 0.0001% or more and 0.0100% or less, Mg: 0.0001% or more and 0.0100% or less, REM: 0.0005% or more and 0.0500% or less, and Bi: 0.0005% or more and 0.050% or less.
[4] In the cold-rolled steel sheet according to any one of [1] to [3], a number density of retained austenite in a range of 1.0 μm from the prior γ grain boundary may be 150/mm² or less.
[5] In the cold-rolled steel sheet according to any one of [1] to [4], a hot-dip galvanized layer may be formed on the surface.
[6] In the cold-rolled steel sheet according to [5], the hot-dip galvanized layer may be a hot-dip galvannealed layer.
[7] A method for manufacturing a cold-rolled steel sheet according to another aspect of the present invention includes: a hot rolling process of directly or once cooling and then heating a cast slab containing, as a chemical composition, by mass %, C: more than 0.140% and less than 0.400%, Si: 1.00% or less, Mn: more than 1.30% and less than 4.00%, P: 0.100% or less, S: 0.010% or less, Al: 0.100% or less, N: 0.0100% or less, Ti: 0% or more and less than 0.050%, Nb: 0% or more and less than 0.050%, V: 0% or more and 0.50% or less, Cu: 0% or more and 1.00% or less, Ni: 0% or more and 1.00% or less, Cr: 0% or more and 1.00% or less, Mo: 0% or more and 0.50% or less, B: 0% or more and 0.0100% or less, Ca: 0% or more and 0.0100% or less, Mg: 0% or more and 0.0100% or less, REM: 0% or more and 0.0500% or less, Bi: 0% or more and 0.050% or less, and a remainder: Fe and impurities, to 1,100° C. or higher, and performing hot rolling on the heated cast slab to obtain a hot-rolled steel sheet; a coiling process of coiling the hot-rolled steel sheet at a temperature of 550° C. or lower; a cold rolling process of descaling the hot-rolled steel sheet after the coiling process and then performing cold rolling on the hot-rolled steel sheet to obtain a cold-rolled steel sheet; an annealing process of heating the cold-rolled steel sheet after the cold rolling process to a soaking temperature of 820° C. or higher and 880° C. or lower so that an average heating rate from 700° C. to the soaking temperature is slower than 10.0° C./sec, and annealing by soaking the cold-rolled steel sheet at the soaking temperature for 30 to 200 seconds; a post-annealing cooling process of subjecting the cold-rolled steel sheet after the annealing process to bending-bending-back deformation one or more times with a bending angle of 90 degrees or more in a temperature range of 800° C. or lower and 700° C. or higher using a roll having a radius of 850 mm or less while applying a tension of 3.0 kN or more, to cooling so that both an average cooling rate from 700° C. to 600° C. and an average cooling rate from 450° C. to 350° C. are 5.0° C./sec or faster, to bending-bending-back deformation one or more times with a bending angle of 90 degrees or more in a temperature range of 350° C. or lower and 50° C. or higher using a roll having a radius of 850 mm or less while applying a tension of 3.0 kN or more, and then to cooling to a cooling stop temperature of 50° C. or higher and 250° C. or lower; and a tempering process of tempering the cold-rolled steel sheet after the post-annealing cooling process at a temperature of 200° C. or higher and 350° C. or lower for 1 second or longer.
[8] In the method for manufacturing a cold-rolled steel sheet according to [7], the chemical composition of the cast slab may contain, by mass %, one or two or more selected from Ti: 0.001% or more and less than 0.050%, Nb: 0.001% or more and less than 0.050%, V: 0.01% or more and 0.50% or less, Cu: 0.01% or more and 1.00% or less, Ni: 0.01% or more and 1.00% or less, Cr: 0.01% or more and 1.00% or less, Mo: 0.01% or more and 0.50% or less, B: 0.0001% or more and 0.0100% or less, Ca: 0.0001% or more and 0.0100% or less, Mg: 0.0001% or more and 0.0100% or less, REM: 0.0005% or more and 0.0500% or less, and Bi: 0.0005% or more and 0.050% or less.
[9] In the method for manufacturing a cold-rolled steel sheet according to [7] or [8], in the post-annealing cooling process, an average cooling rate from 350° C. to the cooling stop temperature may be set to 10° C./sec or slower.
[10] In the method for manufacturing a cold-rolled steel sheet according to any one of [7] to [9], in the post-annealing cooling process, a hot-dip galvanized layer may be formed on a surface of the cold-rolled steel sheet by immersing the cold-rolled steel sheet in a plating bath in a state in which a temperature of the cold-rolled steel sheet is higher than 425° C. and lower than 600° C.

[11] In the method for manufacturing a cold-rolled steel sheet according to any one of [7] to [9], in the post-annealing cooling process, a hot-dip galvanized layer may be formed on a surface of the cold-rolled steel sheet by immersing the cold-rolled steel sheet in a plating bath in a state in which a steel sheet temperature is higher than 425° C. and lower than 600° C., and the hot-dip galvanized layer may be further alloyed.

### Effects of the Invention

According to the above-described aspects of the present invention, it is possible to provide a cold-rolled steel sheet having excellent formability and excellent hydrogen embrittlement resistance, and a method for manufacturing the same.

### EMBODIMENTS OF THE INVENTION

A cold-rolled steel sheet according to an embodiment of the present invention (hereinafter, sometimes simply referred to as a steel sheet according to the present embodiment) and a method for manufacturing the same will be described. The steel sheet according to the present embodiment includes not only a cold-rolled steel sheet having no plating layer on a surface, but also a hot-dip galvanized steel sheet having a hot-dip galvanized layer on a surface or a hot-dip galvannealed steel sheet having a hot-dip galvannealed layer on a surface, and main conditions described below are common to the hot-dip galvanized steel sheet and the hot-dip galvannealed steel sheet.

### Chemical Composition

First, the chemical composition of the steel sheet according to the present embodiment will be described. Hereinafter, “%” indicating an amount of each element in the chemical composition means “mass %” unless otherwise specified.

### [C: More Than 0.140% and Less Than 0.400%]

When a C content is 0.140% or less, it becomes difficult to obtain the above-described metallographic structure, and a target tensile strength cannot be achieved. In addition, bendability decreases. Therefore, the C content is set to more than 0.140%. The C content is preferably more than 0.160%, and more preferably more than 0.180%.

On the other hand, when the C content is 0.400% or more, weldability deteriorates and the bendability deteriorates. In addition, hydrogen embrittlement resistance also deteriorates. Therefore, the C content is set to less than 0.400%. The C content is preferably less than 0.350%, and more preferably less than 0.300%.

### [Si: 1.00% or Less]

When a Si content is more than 1.00%, surface properties of the steel sheet deteriorate. Furthermore, chemical convertibility and platability significantly deteriorate. Therefore, the Si content is set to 1.00% or less. The Si content is preferably 0.80% or less.

On the other hand, Si is an element useful for increasing a strength of the steel sheet by solid solution strengthening. In addition, Si suppresses the generation of cementite, and is thus an element effective in promoting the concentration of C in austenite and generating retained austenite after annealing.

Therefore, Si may be contained. In this case, the Si content is set to preferably 0.01% or more, more preferably 0.10% or more, and even more preferably 0.50% or more.

### [Mn: More Than 1.30% and Less Than 4.00%]

Mn has an action of improving hardenability of steel and is an element effective for obtaining the above-described metallographic structure. When a Mn content is 1.30% or less, it becomes difficult to obtain the above-described metallographic structure. In this case, a sufficient tensile strength cannot be obtained. Therefore, the Mn content is set to more than 1.30%. The Mn content is preferably more than 2.00%, and more preferably more than 2.50%.

On the other hand, when the Mn content is 4.00% or more, an effect of improving the hardenability is diminished due to segregation of Mn, and a material cost increases. Therefore, the Mn content is set to less than 4.00%. The Mn content is preferably less than 3.50%, and more preferably less than 3.00%.

### [P: 0.100% or Less]

P is an element contained in steel as an impurity and is an element that segregates at grain boundaries and embrittles steel. Therefore, a P content is preferably as small as possible and may be 0%. However, in consideration of a time and a cost for removing P, the P content is set to 0.100% or less. The P content is preferably 0.020% or less, and more preferably 0.015% or less.

### [S: 0.010% or Less]

S is an element contained in steel as an impurity and is an element that forms sulfide-based inclusions and deteriorates the bendability. Therefore, a S content is preferably as small as possible and may be 0%. However, in consideration of a time and a cost for removing S, the S content is set to 0.010% or less. The S content is preferably 0.005% or less, more preferably 0.003% or less, and even more preferably 0.001% or less.

### [Al: 0.100% or Less]

On the other hand, when an Al content is too high, not only surface defects are caused by alumina likely to occur, but also a transformation point significantly increases and a volume percentage of ferrite increases. In this case, it becomes difficult to obtain the above-mentioned metallographic structure, and a sufficient tensile strength cannot be obtained. Therefore, the Al content is set to 0.100% or less. The Al content is preferably 0.050% or less, more preferably 0.040% or less, and even more preferably 0.030% or less.

Al is an element having an action of deoxidizing molten steel. In the steel sheet according to the present embodiment, since Si having a deoxidizing action like Al is contained, Al does not necessarily have to be contained, and the Al content may be 0%. However, in a case where Al is contained for the purpose of deoxidation, the Al content is preferably 0.005% or more, and more preferably 0.010% or more for reliable deoxidation. In addition, Al has an action of enhancing stability of austenite like Si and is an effective element for obtaining the above-described metallographic structure. Therefore, Al may be contained from this point of view.

### [N: 0.0100% or Less]

N is an element contained in steel as an impurity and is an element that forms a coarse precipitate and deteriorates the bendability. Therefore, a N content is set to 0.0100% or less. The N content is preferably 0.0060% or less, and more preferably 0.0050% or less. The N content is preferably as small as possible, and may be 0%.

The steel sheet according to the present embodiment contains the above-described elements and a remainder being Fe and impurities, and the steel sheet may further contain one or two or more of elements listed below that affect the strength and the bendability as optional elements. However, since these elements do not necessarily have to be contained, lower limits of all thereof are 0%.

### [Ti: 0% or More and Less Than 0.050%]

### [Nb: 0% or More and Less Than 0.050%]

### [V: 0% or More and 0.50% or Less]

### [Cu: 0% or More and 1.00% or Less]

Ti, Nb, V, and Cu are elements having an action of improving the strength of the steel sheet by precipitation hardening. Therefore, these elements may be contained. In order to sufficiently obtain the above effects, it is preferable that a Ti content and a Nb content are each set to 0.001% or more, and a V content and a Cu content are each set to 0.01% or more. More preferably, the Ti content and the Nb content are each 0.005% or more, and the V content and the Cu content are each 0.05% or more. It is not essential to obtain the above effects. Therefore, it is not necessary to particularly limit lower limits of the Ti content, the Nb content, the V content, and the Cu content, and the lower limits thereof are 0%.

However, when these elements are excessively contained, a recrystallization temperature rises, the metallographic structure of the cold-rolled steel sheet becomes non-uniform, and the bendability is impaired.

Therefore, in a case where these elements are contained, the Ti content is set to less than 0.050%, the Nb content is set to less than 0.050%, the V content is set to 0.50% or less, and the Cu content is set to 1.00% or less. The Ti content is preferably less than 0.030%, and more preferably less than 0.020%. The Nb content is preferably less than 0.030%, and more preferably less than 0.020%. The V content is preferably 0.30% or less. The Cu content is preferably 0.50% or less.

### [Ni: 0% or More and 1.00% or Less]

### [Cr: 0% or More and 1.00% or Less]

### [Mo: 0% or More and 0.50% or Less]

### [B: 0% or More and 0.0100% or Less]

Ni, Cr, Mo, and B are elements that improve the hardenability of steel and contribute to high-strengthening, and are effective elements for obtaining the above-described metallographic structure. Therefore, these elements may be contained. In order to sufficiently obtain the above effects, it is preferable that a Ni content, a Cr content, and a Mo content are each set to 0.01% or more, and/or a B content is set to 0.0001% or more. More preferably, the Ni content, the Cr content, and the Mo content are each 0.05% or more, and the B content is 0.0010% or more. It is not essential to obtain the above effects. Therefore, it is not necessary to particularly limit lower limits of the Ni content, the Cr content, the Mo content, and the B content, and the lower limits thereof are 0%.

However, even if these elements are excessively contained, the effect of the above-described action is saturated, which is uneconomical. Therefore, in a case where these elements are contained, the Ni content and the Cr content are each set to 1.00% or less, the Mo content is set to 0.50% or less, and the B content is set to 0.0100% or less. The Ni content and Cr content are preferably 0.50% or less, the Mo content is preferably 0.20% or less, and the B content is preferably 0.0030% or less.

### [Ca: 0% or More and 0.0100% or Less]

### [Mg: 0% or More and 0.0100% or Less]

### [REM: 0% or More and 0.0500% or Less]

### [Bi: 0% or More and 0.050% or Less]

Ca, Mg, and REM are elements having an action of improving the strength and bendability by adjusting shapes of inclusions. In addition, Bi is an element having an action of improving the strength and bendability by refining a solidification structure. Therefore, these elements may be contained. In order to sufficiently obtain the above effects, it is preferable that a Ca content and a Mg content are each set to 0.0001% or more, and a REM content and a Bi content are each set to 0.005% or more. More preferably, the Ca content and the Mg content are each 0.0008% or more, and the REM content and the Bi content are each 0.007% or more. It is not essential to obtain the above effects. Therefore, it is not necessary to particularly limit lower limits of the Ca content, the Mg content, the REM content, and the Bi content, and the lower limits thereof are 0%.

On the other hand, even if these elements are excessively contained, the effect of the above-described action is saturated, which is uneconomical. Therefore, even in a case where these elements are contained, the Ca content is set to 0.0100% or less, the Mg content is set to 0.0100% or less, the REM content is set to 0.0500% or less, and the Bi content is set to 0.050% or less. Preferably, the Ca content is 0.0020% or less, the Mg content is 0.0020% or less, the REM content is 0.0020% or less, and the Bi content is 0.010% or less. REM means rare earth elements and is a generic term for a total of 17 elements of Sc, Y and lanthanides, and the REM content is a total amount of these elements.

The chemical composition of the steel sheet according to the present embodiment may be measured by a general method. For example, the chemical composition may be measured using inductively coupled plasma-atomic emission spectrometry (ICP-AES) for chips according to JIS G 1201 (2014). In this case, the chemical composition is an average content in an entire sheet thickness. C and S, which cannot be measured by ICP-AES, may be measured using a combustion-infrared absorption method, and N may be measured using an inert gas fusion-thermal conductivity method.

In a case where the steel sheet is provided with a coating such as a plating on a surface thereof, the chemical composition may be analyzed after removing the coating by mechanical grinding or the like. In a case where the coating is a plating layer, the coating may be removed by dissolving the plating layer in an acid solution containing an inhibitor that suppresses the corrosion of the steel sheet.

### Metallographic Structure (Microstructure)

First, the metallographic structure of the steel sheet according to the present embodiment will be described.

In the description of the metallographic structure of the steel sheet according to the present embodiment, microstructural fractions are indicated by volume percentages. Therefore, unless otherwise specified, “%” indicates “volume %”. In addition, in the present embodiment, a surface serving as a reference of a ¼ depth position means a surface of a base steel sheet excluding a plating layer in a case of a plated steel sheet.

A structure at the ¼ depth position (a ¼ thickness position from the surface (the surface of the base steel sheet in the case of the plated steel sheet)) of the steel sheet (including the cold-rolled steel sheet, the hot-dip galvanized steel sheet, and the hot-dip galvannealed steel sheet) according to the present embodiment includes, by volume percentage, retained austenite: more than 1.0% and less than 8.0%, tempered martensite: 80.0% or more, ferrite and bainite: 0% or more and 15.0% or less in total, and martensite: 0% or more 5.0% or less.

### [Retained Austenite: More Than 1.0% and Less Than 8.0%]

Retained austenite improves ductility by a TRIP effect and contributes to an improvement in uniform elongation. Therefore, in the structure at the ¼ thickness position from the surface in a sheet thickness direction, a volume percentage of retained austenite is set to more than 1.0%. The volume percentage of retained austenite is preferably more than 1.5%, and more preferably more than 2.0%.

On the other hand, when the volume percentage of retained austenite becomes excessive, a grain size of retained austenite increases. Such retained austenite having a large grain size becomes coarse and hard martensite after deformation. In this case, the origin of cracks is likely to occur, and the bendability deteriorates. Therefore, the volume percentage of retained austenite is set to less than 8.0%. The volume percentage of retained austenite is preferably less than 7.0%, and more preferably less than 6.0%.

### Tempered Martensite: 80.0% or More

Tempered martensite is a collection of lath-shaped grains similar to martensite (so-called fresh martensite). On the other hand, unlike martensite, tempered martensite is a hard structure containing fine iron-based carbides inside by tempering. Tempered martensite is obtained by tempering martensite generated by cooling or the like after annealing by a heat treatment or the like.

Tempered martensite is a structure that is not brittle and has ductility compared to martensite. In the steel sheet according to the present embodiment, a volume percentage of tempered martensite is set to 80.0% or more in order to improve the strength, bendability, and hydrogen embrittlement resistance. Preferably, the volume percentage of tempered martensite is 85.0% or more. The volume percentage of tempered martensite is less than 99.0%.

### [Ferrite and Bainite: 0% or More and 15.0% or Less in Total]

Ferrite is a soft phase generated by performing dual phase annealing or performing slow cooling after holding in the annealing step. In a case where ferrite is mixed with a hard phase such as martensite, the ductility of the steel sheet is improved. However, in order to achieve a strength as high as 1,310 MPa or more, it is necessary to limit the volume percentage of ferrite.

In addition, bainite is a phase generated by holding at 350° C. or higher and 450° C. or lower for a certain period of time in a process of cooling after holding at an annealing temperature. Bainite is softer than martensite and has an effect of improving the ductility. However, in order to achieve a strength as high as 1,310 MPa or more, it is necessary to limit a volume percentage of bainite as in the case of ferrite described above.

Therefore, the volume percentages of ferrite and bainite are set to 15.0% or less in total. The volume percentages of ferrite and bainite are preferably 10.0% or less. Since ferrite and bainite do not have to be included, lower limits thereof are each 0%. In addition, the volume percentages of ferrite and bainite are not limited.

### [Martensite: 0% or More and 5.0% or Less]

Martensite (fresh martensite) is a collection of lath-shaped grains that are generated by transformation from austenite during final cooling. Since martensite is hard and brittle and tends to be an origin of cracking during deformation, a large volume percentage of martensite causes the deterioration in the bendability. Therefore, the volume percentage of martensite is set to 5.0% or less. The volume percentage of martensite is preferably 3.0% or less, and more preferably 1.0% or less. Since martensite does not have to be included, a lower limit thereof is 0%.

### [Remainder in Microstructure]

The metallographic structure at the ¼ depth position may include, in addition to the above-described phases. pearlite as a remainder in the microstructure. However, pearlite is a structure having cementite in the structure and consumes C (carbon) in steel that contributes to an improvement in strength. Therefore, when the volume percentage of pearlite exceeds 5.0%, the strength of the steel sheet decreases. Therefore, the volume percentage of pearlite is set to 5.0% or less. The volume percentage of pearlite is preferably 3.0% or less, and more preferably 1.0% or less.

The volume percentage of each phase in the metallographic structure at the ¼ depth position of the steel sheet according to the present embodiment is measured as follows.

That is, the volume percentages of ferrite, bainite, martensite, tempered martensite, and pearlite are obtained by collecting a test piece from a random position in a rolling direction and in a width direction of the steel sheet, polishing a longitudinal section parallel to the rolling direction (cross section parallel to the sheet thickness direction), and observing the metallographic structure revealed by Nital etching at the ¼ depth position using a scanning electron microscope (SEM). In the SEM observation, five visual fields of 30 μm×50 μm are observed at a magnification of 3,000-fold, area ratios of each structure are measured from the observed images, and an average value thereof is calculated. In the steel sheet according to the present embodiment, since an area ratio of the longitudinal section parallel to the rolling direction can be regarded as being equal to a volume percentage. the area ratios obtained by the structural observation are each used as volume percentages.

In the measurement of the area ratio of each phase (structure), a region with no substructure revealed and a low luminance is defined as ferrite. In addition, a region with no substructure revealed and a high luminance is defined as martensite or retained austenite. In addition, a region in which a substructure is revealed is defined as tempered martensite or bainite.

Bainite and tempered martensite can be distinguished from each other by further carefully observing carbides in grains.

Specifically, tempered martensite includes martensite laths and cementite generated within the laths. Here, since there are two or more kinds of crystal orientation relationships between martensite laths and cementite, cementite included in the tempered martensite has a plurality of variants.

Bainite is classified into upper bainite and lower bainite. Upper bainite includes lath-shaped bainitic ferrite and cementite generated at the interface between the laths and can be easily distinguished from tempered martensite. Lower bainite includes lath-shaped bainitic ferrite and cementite generated within the laths. Here, there is one kind of crystal orientation relationship between bainitic ferrite and cementite unlike tempered martensite, and cementite included in lower bainite has the same variant. Therefore, lower bainite and tempered martensite can be distinguished from each other on the basis of the variants of cementite.

On the other hand, martensite and retained austenite cannot be clearly distinguished from each other by the SEM observation. Therefore, the volume percentage of martensite is calculated by subtracting the volume percentage of retained austenite calculated by a method described later from a volume percentage of a structure determined to be martensite or retained austenite.

The volume percentage of retained austenite is obtained as described below: a test piece is collected from a random position in the steel sheet, a rolled surface is chemically polished from the surface of the steel sheet to a ¼ thickness position (¼ depth position), and the volume percentage of retained austenite is quantified from integrated intensities of (200) and (210) planes of ferrite and integrated intensities of (200), (220), and (311) planes of austenite by MoKα radiation.

### [Prior γ (Austenite) Grain Size is 5.0 μm or More and 25.0 μm or Less]

[Number Density of Retained Austenite on Prior γ (Austenite) Grain Boundaries is 100/mm² or Less]

Retained austenite is a structure necessary for improving formability. However, the present inventors found that, in a case where retained austenite is present on prior γ grain boundaries, the hydrogen embrittlement resistance decreases. The cause of this is not clear, but it is presumed that hydrogen embrittlement often results in cracking at the prior γ grain boundaries, and the presence of austenite grains with a high solid solubility limit of hydrogen on the prior γ grain boundaries is a source of hydrogen during martensitic transformation during working, so that cracking is more likely to occur. In addition, it is presumed that a hard martensite structure is generated on prior γ grain boundaries by working and thus tends to be an origin of cracking, and this is considered to be a cause of deterioration of the bendability and hydrogen embrittlement resistance. Therefore, in the steel sheet according to the present embodiment, the number density of retained austenite on the prior γ grain boundaries is limited.

Specifically, the number density of retained austenite on the prior γ grain boundaries is set to 100/mm² or less so that excellent hydrogen embrittlement resistance can be obtained even if the volume percentage of retained austenite is more than 1.0%.

In addition, when the prior γ grain size is less than 5.0 μm, the grain size is too small and retained austenite on or in the vicinity of the grain boundaries increases in number density, so that the bendability and hydrogen embrittlement resistance deteriorate. On the other hand, when the prior γ grain size is more than 25.0 μm, although a proportion of prior γ grain boundaries that initially tend to be the origin decreases, strain concentration tends to occur during working, and the bendability and hydrogen embrittlement resistance deteriorate.

[Preferably, Number Density of Retained Austenite in Range of 1.0 μm from Prior γ Grain Boundaries is 150/mm² or Less]

By reducing the number density of not only retained austenite on the prior γ grain boundaries but also retained austenite in the vicinity of the prior γ grain boundaries, the hydrogen embrittlement resistance is further improved. Therefore, in a case of obtaining superior hydrogen embrittlement resistance, it is preferable that the number density of retained austenite (including retained austenite on the prior γ grain boundaries) in a range of 1.0 μm from the prior γ grain boundaries is set to 150/mm² or less.

The prior γ (austenite) grain size, the number density of retained austenite on the prior γ grain boundaries, and the number density of retained austenite in a range of 1.0 μm from the prior γ grain boundaries are obtained by the following method. That is, a longitudinal section parallel to the rolling direction (a cross section parallel to the sheet thickness direction) is cut out and polished, and a range of 200 μm in a thickness direction and 200 μm in a longitudinal direction is measured at the ¼ depth position in three or more visual fields by electron back scattering diffraction (EBSD). Orientation analysis is performed using TSL OIM Analysis, which is a software attached to EBSD, and a boundary with an orientation difference of 5° or more from adjacent measurement points is defined as a grain boundary, and a grain is determined. On the premise that an orientation difference of 3° is allowed between an average crystal orientation of this grain and an average crystal orientation of an adjacent grain, in a case where the grains have a K-S (Kurdjumov-Sachs) orientation relationship, the grains are defined as being the same prior γ grains, and prior γ grains are defined by repeating the orientation analysis with adjacent grains for each grain. Furthermore, the number of grains determined to be the γ phase by the EBSD measurement and be adjacent to this prior γ grain boundary is counted. and the density of retained austenite on the prior γ grains is calculated.

The number density of retained austenite in a range of 1.0 μm from the grain boundary can be obtained in the same manner. Structural observation is performed before the EBSD measurement. In a case where ferrite is present, the prior γ grain boundary becomes unclear. Therefore, positions of grains of ferrite in the same visual field are coordinated and excluded from the range of the prior γ grain boundary in the EBSD measurement.

### Mechanical Properties

### [Tensile Strength is 1,310 MPa or More]

### [Uniform Elongation is 4.0% or More]

### [R/t, Which is Ratio of Limit Bend R to Sheet Thickness at 90° V-Bending, is 5.0 or Less]

In the steel sheet according to the present embodiment, as the strength that contributes to a weight reduction of vehicle bodies of vehicles, a tensile strength (TS) is targeted to be 1,310 MPa or more. From the viewpoint of an impact absorption property, the strength of the steel sheet is preferably 1,400 MPa or more, and more preferably 1,470 MPa or more. An upper limit thereof is not limited, but may be 1,960 MPa or less.

In addition, from the viewpoint of formability, a uniform elongation (uEl) is targeted to be 4.0% or more. In order to improve the formability, the uniform elongation (uEl) is preferably 4.5% or more, and more preferably 5.0% or more.

In addition, from the viewpoint of the formability, a ratio (R/t) of a limit bend R to a sheet thickness t at 90° V-bending is targeted to be 5.0 or less. In order to further improve the formability, (R/t) is preferably 4.0 or less, and more preferably 3.0 or less.

The tensile strength (TS) and the uniform elongation (uEl) are obtained by collecting a JIS No. 5 tensile test piece from the steel sheet in a direction perpendicular to the rolling direction and performing a tensile test according to JIS Z 2241:2011.

In addition, (R/t) is obtained by obtaining a minimum bend radius R, at which no cracking occurs when a 90° V-bending die is used and a radius R is changed at a pitch of 0.5 mm, and dividing the minimum bend radius R by the sheet thickness t.

The steel sheet according to the present embodiment may have a hot-dip galvanized layer on the surface. Corrosion resistance is improved by providing a plating layer on the surface. When there is a concern about holes due to corrosion in a steel sheet for a vehicle, there are cases where the steel sheet cannot be thinned to a certain sheet thickness or less even if the high-strengthening is achieved. One of the purposes of the high-strengthening of the steel sheet is to reduce the weight by thinning. Therefore, even if a high strength steel sheet is developed, an application range of a steel sheet with low corrosion resistance is limited. As a method for solving these problems, it is conceivable to apply plating such as hot-dip galvanizing having high corrosion resistance to the steel sheet. In the steel sheet according to the present embodiment, since the composition of the steel sheet is controlled as described above, hot-dip galvanizing is possible.

The hot-dip galvanized layer may also be a hot-dip galvannealed layer.

### Sheet Thickness

The sheet thickness of the steel sheet according to the present embodiment is not limited, but is preferably 0.8 to 2.6 mm in consideration of a product to which the steel sheet is supposed to be applied.

### Manufacturing Method

The steel sheet according to the present embodiment is capable of obtaining the effects as long as the steel sheet has the above-described configuration, and thus, a manufacturing method thereof is not limited. The steel sheet can be manufactured by a manufacturing method including the following steps (I) to (VI):
(I) a hot rolling step of directly or once cooling and then heating a cast slab to 1,100° C. or higher, and performing hot rolling on the heated cast slab to obtain a hot-rolled steel sheet;
(II) a coiling step of coiling the hot-rolled steel sheet at a temperature of 550° C. or lower;
(III) a cold rolling step of descaling the hot-rolled steel sheet after the coiling step and then performing cold rolling on the hot-rolled steel sheet to obtain a cold-rolled steel sheet;
(IV) an annealing step of heating the cold-rolled steel sheet after the cold rolling step to a soaking temperature of 820° C. or higher and 880° C. or lower so that an average heating rate from 700° C. to the soaking temperature is slower than 10.0° C./sec, and annealing by soaking the cold-rolled steel sheet at the soaking temperature for 30 to 200 seconds;
(V) a post-annealing cooling step of subjecting the cold-rolled steel sheet after the annealing step to bending-bending-back deformation one or more times with a bending angle of 90 degrees or more in a temperature range of 800° C. or lower and 700° C. or higher using a roll having a radius of 850 mm or less while applying a tension of 3.0 kN or more, to cooling so that both an average cooling rate from 700° C. to 600° C. and an average cooling rate from 450° C. to 350° C. are 5.0° C./sec or faster, to bending-bending-back deformation one or more times with a bending angle of 90 degrees or more in a temperature range of 350° C. or lower and 50° C. or higher using a roll having a radius of 850 mm or less while applying a tension of 3.0 kN or more, and then to cooling to a cooling stop temperature of 50° C. or higher and 250° C. or lower; and
(VI) a tempering step of tempering the cold-rolled steel sheet after the post-annealing cooling step at a temperature of 200° C. or higher and 350° C. or lower for 1 second or longer.

Hereinafter, each step will be described.

### [Hot Rolling Step]

The cast slab is directly or once cooled and then heated to 1,100° C. or higher, and the heated cast slab is hot-rolled to obtain the hot-rolled steel sheet.

Hot rolling conditions are not particularly limited.

Since the chemical composition does not substantially change during a manufacturing process, the chemical composition of the cast slab may be the same as the chemical composition of the target cold-rolled steel sheet.

A manufacturing method of the cast slab is not limited. The cast slab is preferably cast by a continuous casting method from the viewpoint of productivity, but may also be manufactured by an ingot-making method or a thin slab casting method.

In a case where a steel piece obtained by continuous casting can be subjected to the hot rolling step while a sufficiently high temperature is maintained, the heating step may be omitted.

### [Coiling Step]

The hot-rolled steel sheet is coiled at a temperature of 550° C. or lower. By setting a coiling temperature 550° C. or lower, the formation of a coarse ferrite structure containing no carbides can be suppressed, and thus carbides can be finely dispersed and precipitated. Since this carbide acts as an origin of austenitic transformation during the subsequent annealing and dissolves as a solid solution after the austenitic transformation, an austenite grain structure having a uniform carbon concentration can be obtained. By cooling such austenite having a uniform carbon concentration while controlling a cooling rate or the like, it is possible to obtain a steel sheet having no retained austenite remaining on the prior γ grain boundaries and having excellent bendability and hydrogen embrittlement resistance.

When the coiling temperature exceeds 550° C., the carbides become coarse and a sufficient effect cannot be obtained.

### [Cold Rolling Step]

The hot-rolled steel sheet after the coiling step is descaled and then cold-rolled to obtain the cold-rolled steel sheet. Although cold rolling conditions are not limited, a rolling reduction ratio (cumulative rolling reduction) is preferably 30% or more from the viewpoint of promoting γ transformation in the annealing step. On the other hand, in order to set the rolling reduction ratio to more than 70%, a cold rolling load is high. Therefore, the rolling reduction ratio may be set to 70% or less.

### [Annealing Step]

In the annealing step, the cold-rolled steel sheet after the cold rolling step is heated so that the soaking temperature (annealing temperature) is 820° C. to 880° C. and the average heating rate from 700° C. to the soaking temperature is slower than 10.0° C./sec, and soaked and annealed at the soaking temperature for 30 to 200 seconds.

When the average heating rate from 700° C. to the soaking temperature exceeds 10.0° C./sec, the carbides generated in the hot-rolled steel sheet may not be dissolved or the diffusion of solid solution carbon may become insufficient, and the carbon concentration does not become uniform. Therefore, a steel sheet having no retained austenite remaining on prior γ grain boundaries and having excellent bendability and hydrogen embrittlement resistance cannot be obtained.

When the soaking temperature is low, austenite single-phase annealing is not achieved, the volume percentage of ferrite increases, and the bendability deteriorates. Therefore, the soaking temperature is set to 820° C. or higher. The soaking temperature is preferably 830° C. or higher. It is easier to secure bendability when the soaking temperature is high. However, when the soaking temperature is too high, prior austenite becomes coarse, and a steel sheet having no retained austenite remaining on prior γ grain boundaries and having excellent bendability and hydrogen embrittlement resistance cannot be obtained. Therefore, the soaking temperature is set to 880° C. or lower. The soaking temperature is preferably 870° C. or lower.

When the soaking time is shorter than 30 seconds, there are cases where austenitizing does not sufficiently progress. On the other hand, when the soaking time exceeds 200 seconds, the productivity decreases. Therefore, the soaking time is set to 200 seconds or shorter.

### [Post-Annealing Cooling Step]

In the post-annealing cooling step, in order to obtain the above-described metallographic structure, the cold-rolled steel sheet after the annealing is cooled to a temperature (cooling stop temperature) of 50° C. or higher and 250° C. or lower so that both the average cooling rate in a ferritic transformation temperature range of 700° C. to 600° C. and the average cooling rate in a bainitic transformation temperature range of 450° C. to 350° C. are 5.0° C./sec or faster. When the cooling rates in the above temperature ranges are slow, the volume percentages of ferrite and bainite at the ¼ depth position increase, and the volume percentage of tempered martensite decreases. As a result, the tensile strength decreases, and the bendability and hydrogen embrittlement resistance deteriorate. Therefore, both the average cooling rates from 700° C. to 600° C. and from 450° C. to 350° C. are set to 5.0° C./sec or faster. The average cooling rates in the above temperature ranges are each preferably 10.0° C./sec or faster, more preferably 15.0° C./sec or faster, and even more preferably 20.0° C./sec or faster.

In addition, in this cooling process, on the premise that the average cooling rates are satisfied, bending-bending-back deformation is applied one or more times with a bending angle of 90 degrees or more in a temperature range of 800° C. or lower and 700° C. or higher using the roll having a radius of 850 mm or less while applying a tension of 3.0 kN or more, and bending-bending-back deformation is further applied one or more times with a bending angle of 90 degrees or more in a temperature range of 350° C. or lower and 50° C. or higher using the roll having a radius of 850 mm or less while applying a tension of 3.0 kN or more.

By applying the bending-bending-back deformation in a temperature range of 800° C. or lower and 700° C. or higher, strain is applied to austenite, and a martensitic transformation nucleus is introduced. The strain particularly enters the vicinity of a grain boundary of austenite, and then promotes martensitic transformation in the vicinity of the grain boundary as the bending-bending-back deformation is applied in a temperature range of 350° C. or lower and 50° C. or higher.

Accordingly, the number density of retained austenite on the prior γ grain boundaries can be reduced. The number density of retained austenite on the prior γ grain boundaries is not sufficiently small when bending-bending-back is performed only in either the low temperature range of 350° C. or lower and 50° C. or higher or the high temperature range of 800° C. or lower and 700° C. or higher. Integrated control of the bending-bending-back performed in each of the high temperature range and the low temperature range, including the control of the average cooling rates in the temperature ranges described above, has the effect of promoting martensitic transformation in the vicinity of the grain boundary, and reducing the number density of retained austenite on the prior γ grain boundaries.

For example, bending is performed with a bending angle of 90 degrees or more in the target temperature range using the roll having a radius of 850 mm or less (along the roll) so that the surface is on an inside, and thereafter bending is performed with a bending angle of 90 degrees or more so that a rear surface is on the inside, whereby predetermined bending-bending-back can be achieved.

The tension during the bending-bending-back is preferably 5.0 kN or more, and more preferably 8.0 kN or more in order to apply strain to the vicinity of the grain boundary, achieve sufficient martensitic transformation, and stabilize sheet passing. Alternatively, the tension during the bending-bending-back in a temperature range of 350° C. to 50° C. may be higher than the tension during the bending-bending-back in a temperature range of 800° C. to 700° C. The tension in the high temperature range is not too strong to suppress the deformation of the steel sheet, and a strong tension is applied in the low temperature range to sufficiently promote the martensitic transformation in the vicinity of the grain boundary.

In the post-annealing cooling step, an average cooling rate in a temperature range of 350° C. or lower is preferably set to 10° C./sec or slower. The average cooling rate is more preferably 7° C./second or slower.

By applying the bending-bending-back as described above and then reducing the cooling rate in temperature range of 350° C. or lower, which is a temperature range in which martensite is generated, martensitic transformation from strain in the vicinity of the grain boundary is promoted, thereby reducing the number density of retained austenite in the vicinity of prior austenite grain boundaries (for example, in a range of 1.0 μm from the prior austenite grain boundaries).

### [Hot-Dip Galvanizing]

### [Alloying]

In a case of manufacturing a cold-rolled steel sheet (hot-dip galvanized steel sheet) provided with a hot-dip galvanized layer on a surface, in the post-annealing cooling step, in a state where the steel sheet temperature is higher than 425° C. and lower than 600° C., the cold-rolled steel sheet may be further subjected to hot-dip galvanizing by being immersed in a plating bath at the same temperature. A composition of the plating bath may be in a known range. In addition, in a case of manufacturing a cold-rolled steel sheet (hot-dip galvannealed steel sheet) subjected to hot-dip galvannealing on a surface, an alloying heat treatment of heating the cold-rolled steel sheet at, for example, higher than 425° C. and lower than 600° C. may be performed subsequent to the above-described hot-dip galvanizing step to form hot-dip galvannealing as a plating. In a case where the plating is performed during the post-annealing cooling step, the plating is performed in a range in which the average cooling rate (5.0° C./sec or faster) in the above-described bainitic transformation temperature range of 450° C. to 350° C. is satisfied.

### [Tempering Step]

In the tempering step, the cold-rolled steel sheet after the post-annealing cooling step is tempered at a temperature of 200° C. or higher and 350° C. or lower for 1 second or longer.

In the cold-rolled steel sheet after the post-annealing cooling step, by cooling to a temperature of 50° C. or higher and 250° C. or lower, untransformed austenite is transformed into martensite. In the tempering step, the cold-rolled steel sheet is tempered at a temperature of 200° C. or higher and 350° C. or lower for 1 second or longer, whereby a structure primarily containing tempered martensite at the ¼ depth position is obtained.

In a case where the hot-dip galvanizing step and/or the alloying step is performed, the cold-rolled steel sheet after the hot-dip galvanizing step or the cold-rolled steel sheet after the hot-dip galvanizing step and the alloying step is cooled to a temperature of 50° C. or higher and 250° C. or lower, and then tempered at a temperature of 200° C. or higher and 350° C. or lower for 1 second or longer. When a tempering temperature is higher than 350° C., the strength of the steel sheet decreases. Therefore, the tempering temperature is set to 350° C. or lower. The tempering temperature is preferably 325° C. or lower, and more preferably 300° C. or lower.

On the other hand, when the tempering temperature is lower than 200° C. the tempering becomes insufficient, and the bendability and hydrogen embrittlement resistance deteriorate. Therefore, the tempering temperature is set to 200° C. or higher. The tempering temperature is preferably 220° C. or higher, and more preferably 250° C. or higher.

A tempering time may be 1 second or longer, but is preferably 5 seconds or longer, and more preferably 10 seconds or longer in order to perform a stable tempering treatment. On the other hand, since there are cases where long tempering decreases the strength of the steel sheet, the tempering time is preferably 750 seconds or shorter, and more preferably 500 seconds or shorter.

### [Skin Pass Rolling Step]

The cold-rolled steel sheet after the tempering step may be cooled to a temperature at which skin pass rolling is possible and then subjected to skin pass rolling. In a case where the cooling after the annealing is water spray cooling, dip cooling, air-water cooling, or the like in which water is used, it is preferable to perform pickling and, subsequently, plating of a small amount of one or two or more of Ni, Fe, Co, Sn, and Cu before the skin pass rolling in order to remove an oxide film formed by contact with water at a high temperature and improve chemical convertibility of the steel sheet. Here, the small amount refers to a plating amount of about 3 to 30 mg/m² on the surface of the steel sheet.

A shape of the steel sheet can be adjusted by the skin pass rolling. An elongation ratio of the skin pass rolling is preferably 0.10% or more. The elongation ratio of the skin pass rolling is more preferably 0.15% or more. On the other hand, when the elongation ratio of the skin pass rolling is high, the volume percentage of retained austenite decreases, and the ductility deteriorates. Therefore, the elongation ratio is preferably set to 1.00% or less. The elongation ratio is more preferably 0.75% or less, and even more preferably 0.50% or less.

### EXAMPLES

The present invention will be described more specifically with reference to examples.

Slabs having the chemical composition shown in Table 1 were cast. The cast slab was heated to 1,100° C. or higher, hot-rolled to 2.8 mm, coiled at the coiling temperature shown in Table 2, and cooled to room temperature.

Thereafter, scale was removed by pickling, cold rolling to 1.4 mm was performed, and then annealing was performed at the soaking temperature shown in

Table 2 for 120 seconds. In the annealing, an average heating rate from 700° C. to the soaking temperature was set as shown in Table 2.

After the annealing, while performing the bending-bending-back with 90° or more in a temperature range of 800° C. to 700° C. and a temperature range of 350° C. to 50° C., cooling to a cooling stop temperature of 50° C. or higher and 250° C. or lower was performed so that both average cooling rates in a temperature range of 700° C. to 600° C. and in a temperature range of 450° C. to 350° C. were 20° C./sec or faster. Regarding the bending-bending-back, bending was performed with a bending angle of 90 degrees or more so that a surface was on an inside, and thereafter bending was performed with a bending angle of 90 degrees or more so that a rear surface was on the inside, in the target temperature range along a roll having the radius shown in Table 2 while applying the tension of Table 2, whereby the bending-bending-back was performed. In addition, the average cooling rate in a temperature range of 350° C. or lower was as shown in Table 2.

Thereafter, tempering was performed at 200° C. to 350° C. for 1 to 500 seconds.

In some of the examples, hot-dip galvanizing and alloying were performed during a post-annealing cooling step. In Table 4, CR indicates a cold-rolled steel sheet that has not been galvanized, GI indicates a hot-dip galvanized steel sheet, and GA indicates a hot-dip galvannealed steel sheet.

In the hot-dip galvanizing, a hot-dip galvanized layer of 35 to 65 g/m² was formed in the middle of the post-annealing cooling step. A hot-dip galvannealed steel sheet was obtained by performing hot-dip galvanizing in a state of higher than 425° C. and lower than 600° C. through immersion in a plating bath having an equivalent temperature, and then further performing alloying at a temperature of higher than 425° C. and lower than 600°.

TABLE 1

| | Chemical composition (mass %) (remainder: Fe and impurities). | | | | | | | |
|---|---|---|---|---|---|---|---|---|
| Steel | C | Si | Mn | P | S | Al | N | Others |
| A | 0.137 | 0.42 | 2.12 | 0.008 | 0.001 | 0.033 | 0.0038 | |
| B | 0.226 | 0.03 | 2.42 | 0.009 | 0.001 | 0.033 | 0.0030 | |
| C | 0.206 | 0.96 | 1.26 | 0.008 | 0.001 | 0.028 | 0.0028 | |
| D | 0.409 | 0.43 | 3.89 | 0.010 | 0.001 | 0.035 | 0.0033 | |
| B | 0.220 | 1.04 | 2.31 | 0.009 | 0.001 | 0.031 | 0.0027 | |
| F | 0.324 | 0.81 | 4.04 | 0.010 | 0.001 | 0.032 | 0.0032 | |
| G | 0.223 | 0.77 | 2.22 | 0.009 | 0.001 | 0.108 | 0.0031 | |
| H | 0.239 | 0.72 | 2.65 | 0.009 | 0.001 | 0.039 | 0.0032 | |
| I | 0.243 | 0.71 | 2.56 | 0.009 | 0.001 | 0.032 | 0.0033 | |
| J | 0.223 | 0.70 | 2.75 | 0.010 | 0.001 | 0.035 | 0.0034 | |
| K | 0.193 | 0.75 | 3.21 | 0.009 | 0.001 | 0.029 | 0.0029 | |
| L | 0.224 | 0.73 | 2.45 | 0.010 | 0.001 | 0.031 | 0.0036 | V: 0.09 |
| M | 0.243 | 0.74 | 2.56 | 0.009 | 0.001 | 0.034 | 0.0031 | Ti: 0.023 Nb: 0.009 B: 0.0018 |
| N | 0.340 | 0.75 | 2.3 | 0.008 | 0.001 | 0.033 | 0.0030 | Mo: 0.09 Cr: 0.27 |
| O | 0.231 | 0.76 | 2.56 | 0.009 | 0.001 | 0.029 | 0.0031 | Bi: 0.008 REM: 0.0010 |
| P | 0.232 | 0.74 | 2.47 | 0.009 | 0.001 | 0.028 | 0.0032 | Ca: 0.0090 Mg: 0.00010 |

TABLE 2

| | | | | | Post-annealing cooling process | | | | |
|---|---|---|---|---|---|---|---|---|---|
| | | | Annealing step | | Bending- | | Bending- | | |
| | | | Average | | bending-back | | bending-back | | Average |
| | | Coiling | heating rate | | at 800° C. to | | at 350° C. to | | cooling |
| | | step | from 700° C. | | 700° C. | | 50° C. | | rate to |
| | | Coiling | to soaking | Soaking | | Roll | | Roll | 350° C. |
| Test | | temperature | temperature | temperature | Tension | radius | Tension | radius | or lower |
| No. | Steel | (° C.) | (° C./sec) | (° C.) | (kN) | (mm) | (kN) | (mm) | (° C./sec) |
| 1 | A | 510 | 4.5 | 825 | 9.3 | 600 | 9.8 | 600 | 7 |
| 2 | B | 520 | 4.5 | 825 | 9.8 | 600 | 9.5 | 600 | 5 |
| 3 | B | 520 | 4.5 | 845 | 9.8 | 600 | 10.2 | 600 | 5 |
| 4 | C | 515 | 4.5 | 830 | 9.5 | 600 | 10.3 | 600 | 5 |
| 5 | D | 520 | 4.5 | 830 | 8.9 | 600 | 10.4 | 600 | 6 |
| 6 | B | 525 | 4.5 | 825 | 9.5 | 600 | 9.8 | 600 | 5 |
| 7 | B | 520 | 4.5 | 840 | 9.2 | 600 | 9.8 | 600 | 5 |
| 8 | F | 510 | 4.5 | 830 | 10.2 | 600 | 10.5 | 600 | 6 |
| 9 | G | 530 | 4.5 | 835 | 10.1 | 600 | 10.4 | 600 | 6 |
| 10 | H | 520 | 4.5 | 850 | 9.5 | 600 | 9.9 | 600 | 5 |
| 11 | H | 560 | 4.5 | 865 | 10.4 | 600 | 10.6 | 600 | 6 |
| 12 | H | 540 | 4.5 | 830 | 9.8 | 600 | 10.1 | 600 | 15 |
| 13 | H | 520 | 4.5 | 810 | 10.3 | 600 | 10.8 | 600 | 5 |
| 14 | H | 525 | 4.5 | 845 | 2.5 | 600 | 2.8 | 600 | 6 |
| 15 | H | 515 | 4.5 | 850 | 9.5 | 900 | 10.2 | 900 | 5 |
| 16 | H | 535 | 4.5 | 890 | 9.4 | 600 | 9.8 | 600 | 5 |
| 17 | H | 520 | 4.5 | 825 | 9.6 | 600 | 9.9 | 600 | 5 |
| 18 | H | 525 | 4.5 | 830 | 10.1 | 600 | 10.4 | 600 | 5 |
| 19 | H | 515 | 4.5 | 830 | 9.5 | 600 | 10.1 | 600 | 6 |
| 20 | H | 515 | 4.5 | 850 | 9.7 | 600 | 10.2 | 600 | 6 |
| 21 | H | 520 | 4.5 | 845 | 10.5 | 600 | 10.7 | 600 | 5 |
| 22 | H | 515 | 4.5 | 845 | 9.5 | 600 | 9.8 | 600 | 5 |
| 23 | H | 520 | 4.5 | 850 | 10.2 | 600 | 10.6 | 600 | 6 |
| 24 | H | 520 | 4.5 | 825 | 9.2 | 600 | 9.8 | 600 | 5 |
| 25 | I | 515 | 4.5 | 845 | 10.2 | 600 | 10.6 | 600 | 5 |
| 26 | J | 515 | 4.5 | 865 | 10.1 | 600 | 10.4 | 600 | 5 |
| 27 | K | 525 | 4.5 | 840 | 9.5 | 600 | 9.7 | 600 | 6 |
| 28 | L | 520 | 4.5 | 845 | 10.4 | 600 | 10.7 | 600 | 5 |
| 29 | M | 515 | 4.5 | 840 | 10.2 | 600 | 10.5 | 600 | 5 |
| 30 | M | 545 | 4.5 | 840 | 10.1 | 600 | 10.4 | 600 | 15 |
| 31 | N | 515 | 4.5 | 830 | 10.1 | 600 | 10.3 | 600 | 6 |
| 32 | O | 515 | 4.5 | 825 | 9.6 | 600 | 9.9 | 600 | 6 |
| 33 | O | 520 | 4.5 | 845 | 10.3 | 600 | 10.5 | 600 | 5 |
| 34 | P | 510 | 4.5 | 850 | 10.2 | 600 | 10.5 | 600 | 5 |

From the obtained cold-rolled steel sheets, by the above-described methods, the volume percentages (retained austenite, tempered martensite, ferrite, bainite, martensite, and pearlite) of the metallographic structure at the ¼ depth position, the prior γ grain sizes, the number density of retained austenite on the prior γ grain boundaries, and the number density of retained austenite in a range of 1.0 μm from the prior γ grain boundaries were measured.

The results are shown in Table 3.

In addition, the tensile strength (TS) and the uniform elongation (uEl) were obtained by collecting a JIS No. 5 tensile test piece from the cold-rolled steel sheet in a direction perpendicular to the rolling direction, and conducting a tensile test according to JIS Z 2241:2011.

The following test was conducted to evaluate the hydrogen embrittlement resistance.

That is, a test piece having a mechanically ground end surface was bent into a U-shape by a press bending method to prepare a U-bending test piece with a smallest possible bend radius R, the U-bending test piece was tightened with bolts to be elastically deformed so that non-bent portions were parallel to each other, and thereafter a delayed fracture acceleration test in which hydrogen was allowed to penetrate into the steel sheet was conducted by immersing the U-bending test piece in hydrochloric acid having a pH of 1. Those in which cracking did not occur even when an immersion time was 100 hours were evaluated as steel sheets having a good (O: OK) delayed fracture resistance property, and those in which cracking had occurred were evaluated as defective (X: NG). In order to remove an influence of plating, regarding a plating material, a plating layer was removed with hydrochloric acid containing an inhibitor before the test, and thereafter the hydrogen embrittlement resistance was evaluated.

The results are shown in Table 4.

(R/t), which is an index of bendability, was obtained by obtaining a minimum bend radius R at which no cracking had occurred when a 90° V-bending die was used while changing a radius R at a pitch of 0.5 mm, and dividing the minimum bend radius R by a sheet thickness of 1.4 mm.

The results are shown in Table 4.

TABLE 3

| | Metallographic structure at ¼ depth position | | | | | | | | | |
|---|---|---|---|---|---|---|---|---|---|---|
| | | | | | | | | | | Number |
| | | | | | | | | | Number | density of |
| | | | | | | | | | density of | retained |
| | | | | | | | | | retained | austenite |
| | | | | | | | | | austenite | in range of |
| | Volume percentage of each phase | | | | | | | Prior | on prior | 1.0 μm |
| | | | Ferrite and | | | | | austenite | austenite | from prior |
| | | | bainite in | Retained | | Tempered | | grain | grain | γ grain |
| Test | Ferrite | Bainite | total | austenite | Martensite | martensite | Remainder | size | boundaries | boundaries |
| No. | (volume %) | (volume %) | (volume %) | (volume %) | (volume %) | (volume %) | (volume %) | (μm) | (/mm²) | (/mm²) |
| 1 | 4.3 | 11.2 | 15.5 | 2.8 | 0.0 | 81.7 | 0.0 | 7.1 | 48 | 97 |
| 2 | 0.0 | 13.4 | 13.4 | 1.3 | 0.0 | 85.3 | 0.0 | 6.9 | 39 | 61 |
| 3 | 0.0 | 5.2 | 5.2 | 0.8 | 0.0 | 94.0 | 0.0 | 12.5 | 25 | 41 |
| 4 | 3.4 | 25.6 | 29.0 | 5.3 | 0.0 | 65.7 | 0.0 | 7.4 | 67 | 88 |
| 5 | 0.0 | 0.0 | 0.0 | 7.8 | 5.3 | 86.9 | 0.0 | 7.5 | 91 | 139 |
| 6 | 15.2 | 32.4 | 47.6 | 10.0 | 6.5 | 35.9 | 0.0 | 6.8 | 104 | 159 |
| 7 | 2.1 | 14.8 | 16.9 | 4.9 | 0.0 | 78.2 | 0.0 | 10.9 | 52 | 81 |
| 8 | 0.0 | 0.0 | 0.0 | 6.5 | 5.7 | 87.8 | 0.0 | 8.4 | 64 | 86 |
| 9 | 24.6 | 3.4 | 28.0 | 6.2 | 0.0 | 65.8 | 0.0 | 10.0 | 51 | 79 |
| 10 | 0.0 | 9.7 | 9.6 | 4.9 | 0.0 | 85.5 | 0.0 | 13.0 | 50 | 78 |
| 11 | 0.0 | 9.6 | 9.8 | 4.8 | 0.0 | 85.4 | 0.0 | 25.1 | 106 | 155 |
| 12 | 2.1 | 10.1 | 12.2 | 5.0 | 0.0 | 82.8 | 0.0 | 7.2 | 96 | 153 |
| 13 | 20.5 | 2.1 | 22.6 | 5.9 | 1.3 | 70.2 | 0.0 | 4.2 | 106 | 157 |
| 14 | 0.0 | 9.6 | 9.6 | 5.8 | 1.4 | 83.2 | 0.0 | 12.0 | 103 | 154 |
| 15 | 0.0 | 9.4 | 9.4 | 6.1 | 1.3 | 83.2 | 0.0 | 13.1 | 105 | 155 |
| 16 | 0.0 | 2.6 | 2.6 | 5.2 | 0.0 | 92.2 | 0.0 | 25.3 | 104 | 156 |
| 17 | 7.9 | 1.2 | 9.1 | 5.6 | 0.0 | 84.7 | 0.6 | 8.0 | 63 | 88 |
| 18 | 3.4 | 2.1 | 5.5 | 5.5 | 0.0 | 88.8 | 0.2 | 8.5 | 62 | 86 |
| 19 | 3.5 | 0.8 | 4.3 | 5.3 | 0.0 | 90.4 | 0.0 | 8.2 | 64 | 88 |
| 20 | 0.0 | 0.0 | 0.0 | 5.2 | 0.0 | 94.8 | 0.0 | 13.0 | 49 | 69 |
| 21 | 0.0 | 9.8 | 9.8 | 6.0 | 0.0 | 84.2 | 0.0 | 11.2 | 52 | 71 |
| 22 | 0.0 | 13.5 | 13.5 | 6.2 | 0.0 | 80.3 | 0.0 | 11.4 | 53 | 75 |
| 23 | 0.0 | 10.8 | 10.8 | 5.3 | 0.0 | 83.9 | 0.0 | 12.6 | 50 | 73 |
| 24 | 10.6 | 0.0 | 10.6 | 5.2 | 0.0 | 82.1 | 2.1 | 7.5 | 64 | 90 |
| 25 | 0.0 | 9.0 | 9.0 | 5.4 | 0.0 | 85.6 | 0.0 | 11.2 | 52 | 73 |
| 26 | 0.0 | 0.0 | 0.0 | 5.2 | 0.0 | 94.8 | 0.0 | 20.1 | 81 | 127 |
| 27 | 0.0 | 0.0 | 0.0 | 5.2 | 0.0 | 94.8 | 0.0 | 10.2 | 52 | 71 |
| 28 | 0.0 | 7.9 | 7.9 | 5.5 | 0.0 | 86.6 | 0.0 | 7.9 | 63 | 90 |
| 29 | 0.0 | 9.8 | 9.8 | 5.6 | 0.0 | 84.6 | 0.0 | 7.1 | 64 | 91 |
| 30 | 0.0 | 9.6 | 9.6 | 5.5 | 0.0 | 84.9 | 0.0 | 5.7 | 97 | 153 |
| 31 | 7.1 | 2.0 | 9.1 | 7.3 | 2.6 | 80.1 | 0.9 | 8.4 | 76 | 122 |
| 32 | 3.5 | 6.2 | 9.7 | 5.5 | 0.0 | 84.8 | 0.0 | 7.9 | 64 | 89 |
| 33 | 0.0 | 8.4 | 8.4 | 5.4 | 0.0 | 86.2 | 0.0 | 10.6 | 54 | 74 |
| 34 | 0.0 | 9.5 | 9.5 | 5.5 | 0.0 | 85.0 | 0.0 | 11.9 | 52 | 72 |

TABLE 4

| | | Mechanical properties | | | | |
|---|---|---|---|---|---|---|
| | Presence or | | | Limit | | |
| | absence | | | bend | Hydrogen | |
| Test | of plating | TS | uE1 | radius | embrittlement | |
| No. | CR/GI/GA | (MPa) | (%) | (R/t) | resistance | Note |
| 1 | CR | 1291 | 5.1 | 5.0 | ◯ | Comparative Example |
| 2 | CR | 1492 | 5.1 | 3.9 | ◯ | Invention Example |
| 3 | CR | 1567 | 3.9 | 2.9 | ◯ | Comparative Example |
| 4 | CR | 1298 | 7.3 | 5.0 | ◯ | Comparative Example |
| 5 | CR | 1975 | 6.2 | 6.4 | X | Comparative Example |
| 6 | CR | 930 | 15.5 | 5.0 | ◯ | Comparative Example |
| 7 | CR | 1424 | 6.5 | 5.4 | ◯ | Comparative Example |
| 8 | GA | 1653 | 6.3 | 6.8 | X | Comparative Example |
| 9 | CR | 1297 | 8.2 | 4.6 | ◯ | Comparative Example |
| 10 | CR | 1488 | 6.1 | 2.1 | ◯ | Invention Example |
| 11 | CR | 1485 | 6.2 | 5.4 | X | Comparative Example |
| 12 | CR | 1487 | 6.1 | 3.9 | ◯ | Invention Example |
| 13 | CR | 1299 | 7.6 | 5.4 | X | Comparative Example |
| 14 | CR | 1503 | 6.1 | 5.4 | X | Comparative Example |
| 15 | GA | 1496 | 5.9 | 5.4 | X | Comparative Example |
| 16 | CR | 1554 | 5.7 | 5.4 | X | Comparative Example |
| 17 | GA | 1486 | 6.3 | 2.1 | ◯ | Invention Example |
| 18 | CR | 1491 | 6.2 | 2.1 | ◯ | Invention Example |
| 19 | GA | 1488 | 6.4 | 2.1 | ◯ | Invention Example |
| 20 | GI | 1550 | 5.6 | 1.8 | ◯ | Invention Example |
| 21 | CR | 1450 | 7.1 | 2.9 | ◯ | Invention Example |
| 22 | GA | 1420 | 6.7 | 2.5 | ◯ | Invention Example |
| 23 | CR | 1463 | 6.7 | 2.5 | ◯ | Invention Example |
| 24 | GI | 1418 | 6.8 | 2.5 | ◯ | Invention Example |
| 25 | CR | 1488 | 6.7 | 2.1 | ◯ | Invention Example |
| 26 | GA | 1579 | 6.2 | 2.1 | ◯ | Invention Example |
| 27 | CR | 1446 | 6.5 | 1.8 | ◯ | Invention Example |
| 28 | CR | 1460 | 6.5 | 2.1 | ◯ | Invention Example |
| 29 | GA | 1489 | 6.4 | 2.1 | ◯ | Invention Example |
| 30 | GA | 1485 | 6.4 | 3.9 | ◯ | Invention Example |
| 31 | CR | 1813 | 6.5 | 3.9 | ◯ | Invention Example |
| 32 | GA | 1465 | 6.3 | 2.1 | ◯ | Invention Example |
| 33 | CR | 1489 | 6.4 | 2.1 | ◯ | Invention Example |
| 34 | GA | 1472 | 6.6 | 2.1 | ◯ | Invention Example |

As can be seen from Tables 1 to 4, all of present invention examples (Test Nos. 2, 10, 12, and 17 to 34) had a TS of 1,310 MPa or more, a uEl of 4.0% or more, an (R/t) of 5.0 or less, and good hydrogen embrittlement resistance.

Contrary to this, in Test Nos. 1, 3 to 9, 11, and 13 to 16 (comparative examples) in which any of the chemical composition and the manufacturing method was outside of the range of the present invention and the metallographic structure at the ¼ depth position, the prior γ grain size, the number density of retained γ present on the prior γ grain boundaries, or texture were outside of the ranges of the present invention, any one or more of the tensile strength, uniform elongation, R/t, and hydrogen embrittlement resistance did not achieve the target

1. A cold-rolled steel sheet comprising, as a chemical composition, by mass %:
C: more than 0.140% and less than 0.400%;
Si: 1.00% or less;
Mn: more than 1.30% and less than 4.00%;
P: 0.100% or less;
S: 0.010% or less;
Al: 0.100% or less;
N: 0.0100% or less;
Ti: 0% or more and less than 0.050%;
Nb: 0% or more and less than 0.050%;
V: 0% or more and 0.50% or less;
Cu: 0% or more and 1.00% or less;
Ni: 0% or more and 1.00% or less;
Cr: 0% or more and 1.00% or less;
Mo: 0% or more and 0.50% or less;
B: 0% or more and 0.0100% or less;
Ca: 0% or more and 0.0100% or less;
Mg: 0% or more and 0.0100% or less;
REM: 0% or more and 0.0500% or less;
Bi: 0% or more and 0.050% or less; and
a remainder: Fe and impurities,
wherein a metallographic structure at a ¼ depth position, which is a ¼ thickness position from a surface, contains, by volume percentage,
retained austenite: more than 1.0% and less than 8.0%,
tempered martensite: 80.0% or more,
ferrite and bainite: 0% or more and 15.0% or less in total, and
martensite: 0% or more and 5.0% or less, and
in the metallographic structure, a prior γ grain size is 5.0 μm or more and 25.0 μm or less, and a number density of retained γ on a prior γ grain boundary is 100/mm² or less.

2. The cold-rolled steel sheet according to claim 1,
wherein a tensile strength is 1,310 MPa or more, a uniform elongation is 4.0% or more, and R/t, which is a ratio of a limit bend R to a sheet thickness at 90° V-bending is 5.0 or less.

3. The cold-rolled steel sheet according to claim 1,
wherein the chemical composition contains, by mass %, one or more of
Ti: 0.001% or more and less than 0.050%,
Nb: 0.001% or more and less than 0.050%,
V: 0.01% or more and 0.50% or less,
Cu: 0.01% or more and 1.00% or less,
Ni: 0.01% or more and 1.00% or less,
Cr: 0.01% or more and 1.00% or less,
Mo: 0.01% or more and 0.50% or less,
B: 0.0001% or more and 0.0100% or less,
Ca: 0.0001% or more and 0.0100% or less,
Mg: 0.0001% or more and 0.0100% or less,
REM: 0.0005% or more and 0.0500% or less, and
Bi: 0.0005% or more and 0.050% or less.

4. The cold-rolled steel sheet according to claim 1,
wherein a number density of retained austenite in a range of 1.0 μm from the prior γ grain boundary is 150/mm² or less.

5. The cold-rolled steel sheet according to claim 1,
wherein a hot-dip galvanized layer is formed on the surface.

6. The cold-rolled steel sheet according to claim 5,
wherein the hot-dip galvanized layer is a hot-dip galvannealed layer.

7. A method for manufacturing a cold-rolled steel sheet, comprising:
a hot rolling process of directly or once cooling and then heating a cast slab containing, as a chemical composition, by mass %, C: more than 0.140% and less than 0.400%, Si: 1.00% or less, Mn: more than 1.30% and less than 4.00%, P: 0.100% or less, S: 0.010% or less, Al: 0.100% or less, N: 0.0100% or less, Ti: 0% or more and less than 0.050%, Nb: 0% or more and less than 0.050%, V: 0% or more and 0.50% or less, Cu: 0% or more and 1.00% or less, Ni: 0% or more and 1.00% or less, Cr: 0% or more and 1.00% or less, Mo: 0% or more and 0.50% or less, B: 0% or more and 0.0100% or less, Ca: 0% or more and 0.0100% or less, Mg: 0% or more and 0.0100% or less, REM: 0% or more and 0.0500% or less, Bi: 0% or more and 0.050% or less, and a remainder: Fe and impurities, to 1,100° C. or higher, and performing hot rolling on the heated cast slab to obtain a hot-rolled steel sheet;
a coiling process of coiling the hot-rolled steel sheet at a temperature of 550° C. or lower;
a cold rolling process of descaling the hot-rolled steel sheet after the coiling process and then performing cold rolling on the hot-rolled steel sheet to obtain a cold-rolled steel sheet;
an annealing process of heating the cold-rolled steel sheet after the cold rolling process to a soaking temperature of 820° C. or higher and 880° C. or lower so that an average heating rate from 700° C. to the soaking temperature is slower than 10.0° C./sec, and annealing by soaking the cold-rolled steel sheet at the soaking temperature for 30 to 200 seconds;
a post-annealing cooling process of subjecting the cold-rolled steel sheet after the annealing process to bending-bending-back deformation one or more times with a bending angle of 90 degrees or more in a temperature range of 800° C. or lower and 700° C. or higher using a roll having a radius of 850 mm or less while applying a tension of 3.0 kN or more, to cooling so that both an average cooling rate from 700° C. to 600° C. and an average cooling rate from 450° C. to 350° C. are 5.0° C./sec or faster, to bending-bending-back deformation one or more times with a bending angle of 90 degrees or more in a temperature range of 350° C. or lower and 50° C. or higher using a roll having a radius of 850 mm or less while applying a tension of 3.0 kN or more, and then to cooling to a cooling stop temperature of 50° C. or higher and 250° C. or lower; and
a tempering process of tempering the cold-rolled steel sheet after the post-annealing cooling process at a temperature of 200° C. or higher and 350° C. or lower for 1 second or longer.

8. The method for manufacturing a cold-rolled steel sheet according to claim 7,
wherein the chemical composition of the cast slab contains, by mass %, one or more of
Ti: 0.001% or more and less than 0.050%,
Nb: 0.001% or more and less than 0.050%,
V: 0.01% or more and 0.50% or less,
Cu: 0.01% or more and 1.00% or less,
Ni: 0.01% or more and 1.00% or less,
Cr: 0.01% or more and 1.00% or less,
Mo: 0.01% or more and 0.50% or less,
B: 0.0001% or more and 0.0100% or less,
Ca: 0.0001% or more and 0.0100% or less,
Mg: 0.0001% or more and 0.0100% or less,
REM: 0.0005% or more and 0.0500% or less, and
Bi: 0.0005% or more and 0.050% or less.

9. The method for manufacturing a cold-rolled steel sheet according to claim 7,
wherein, in the post-annealing cooling process, an average cooling rate from 350° C. to the cooling stop temperature is set to 10° C./sec or slower.

10. The method for manufacturing a cold-rolled steel sheet according to claim 7,
wherein, in the post-annealing cooling process, a hot-dip galvanized layer is formed on a surface of the cold-rolled steel sheet by immersing the cold-rolled steel sheet in a plating bath in a state in which a temperature of the cold-rolled steel sheet is higher than 425° C. and lower than 600° C.

11. The method for manufacturing a cold-rolled steel sheet according to claim 7,
wherein, in the post-annealing cooling process, a hot-dip galvanized layer is formed on a surface of the cold-rolled steel sheet by immersing the cold-rolled steel sheet in a plating bath in a state in which a steel sheet temperature is higher than 425° C. and lower than 600° C., and the hot-dip galvanized layer is further alloyed.
